(19) United States
(12) Patent Application Publication
(10) Pub. No.: US 2006/0044227 A1
(43) Pub. Date: Mar. 2, 2006

(54) Selecting adjustment for OLED drive voltage

(75) Inventor: David Harold Hadcock, Ontario, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/871,192

(22) Filed: Jun. 18, 2004

(51) Int. Cl. G09G 3/30

(52) U.S. Cl. 345/76

(57) ABSTRACT

A method for selecting an adjustment for at least one drive voltage used to drive an OLED display to reduce power consumption including operating the display to produce a calibration curve which depicts the drive voltage versus current or luminance, and selecting the adjustment for the drive voltage based upon the calibration curve so as to reduce the power consumed by the OLED display while maintaining desired luminance throughout the lifetime of the OLED display.

### CROSS REFERENCE TO RELATED APPLICATIONS

Reference is made to commonly assigned U.S. patent application Ser. No. 10/767,288 filed Jan. 28, 2004 by Seiichi Mizukoshi et al., entitled “Setting Black Levels in Organic EL Display Devices”, and commonly assigned U.S. patent application Ser. No. 10/812,546 filed Mar. 29, 2004 by Seiichi Mizukoshi et al., entitled “Controlling Current in Display Device”, the disclosures of which are herein incorporated by reference.

### FIELD OF THE INVENTION

The present invention relates to OLED displays and to reducing the power consumption thereof.

### BACKGROUND OF THE INVENTION

In electroluminescent (EL) displays (also known as organic light-emitting diode devices, or OLED devices) the basic OLED device has in common a spaced anode and cathode, and an organic EL medium sandwiched between the anode and the cathode. The organic EL medium can include of one or more layers of organic thin films, where one of the layers is primarily responsible for light generation or electroluminescence. This particular layer is generally referred to as the emissive layer of the organic EL medium. Other organic layers present in the organic EL medium can provide electronic transport functions primarily and are referred to as either the hole-transporting layer (for hole transport) or electron-transporting layer (for electron transport). A voltage difference is established between the anode and cathode, which causes current to pass through the organic EL medium and leads to electroluminescence.

Organic EL displays are frequently driven by active matrix circuitry in order to produce high performance devices. In an active matrix configuration, each pixel is driven by multiple circuit elements such as two or more transistors, one or more capacitors, power lines, and signal lines. For multicolor devices, a pixel is divided into subpixels, each with a complete set of circuit elements. For a RGB (red, green, blue) device, each pixel includes 3 subpixels, which emit red, green, and blue light. Examples of such active matrix organic EL devices are provided in U.S. Pat. Nos. 5,550,066, 6,281,634, and 6,456,013, and EP1 102 317 A2.

A problem with existing OLED devices is that of power consumption. Because of inherent manufacturing variability in the production of OLED devices, some consume more power than others. To assure that all OLED devices have sufficient power for driving the display, the drive voltage, and therefore the power level, is frequently set at a level sufficient to drive the worst case device. This uses excess power for devices that are not as demanding.

### SUMMARY OF THE INVENTION

It is therefore an object of the present invention to provide a method for reducing power consumption for an OLED display.

This object is achieved by a method for selecting an adjustment for at least one drive voltage used to drive an OLED display to reduce power consumption, comprising:
a) operating the display to produce a calibration curve which depicts the drive voltage versus current or luminance; and
b) selecting the adjustment for the drive voltage based upon the calibration curve so as to reduce the power consumed by the OLED display while maintaining desired luminescence throughout the lifetime of the OLED display.

### ADVANTAGES

It is an advantage of this invention that it provides for a lower power consumption of an OLED device.

It is another advantage of this invention that it can provide for an increased lifetime for an OLED device.

It is a further advantage of this invention that it can improve the efficiency of the cathode power supply.

It is a still further advantage of this invention that it can reduce the amount of heat produced by an OLED device.

### BRIEF DESCRIPTION OF THE DRAWINGS

FIG. 1 is a schematic of the basic circuitry of an OLED pixel;

FIG. 2 is a graphical representation of a current-voltage curve for an OLED device;

FIG. 3 is a graphical representation of current vs. voltage curves for new and aged OLED devices in comparison to the characteristic curves of a thin-film transistor;

FIG. 4 is a schematic view of a measurement circuit and apparatus that can be used according to the method of this invention;

FIG. 5 is a block diagram of one embodiment of a method for selecting an adjustment for a drive voltage used to drive an OLED display to reduce power consumption according to this invention;

FIG. 6 is a calibration curve obtained by the method of this invention;

FIG. 7 shows how a selected adjustment for the drive voltage can change based on the usage of an OLED display;

FIG. 8 is a series of calibration curves obtained by the method of this invention for a display panel at several different display brightness levels; and

FIG. 9 is a series of calibration curves obtained by the method of this invention for the emission of three different color channels of a full-color OLED display.

### DETAILED DESCRIPTION OF THE INVENTION

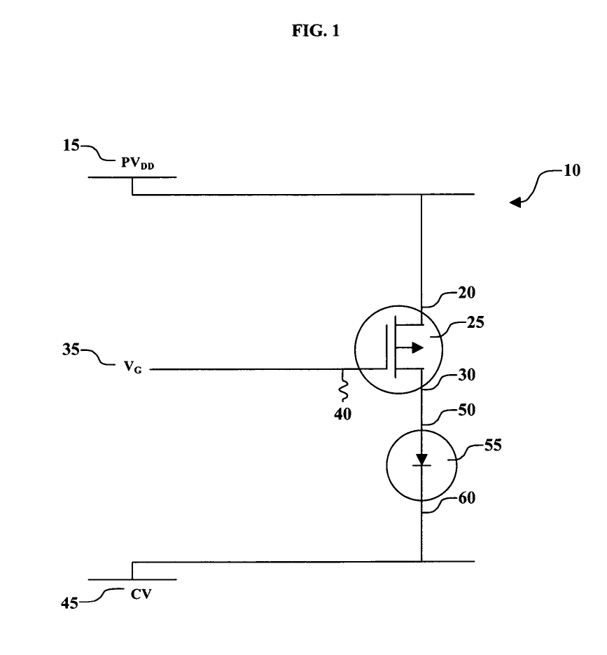

FIG. 1 shows a schematic of one embodiment of the basic circuitry of an OLED pixel of an active matrix display. OLED circuit 10 includes a p-type thin-film transistor 25 and the organic layers 55 of an OLED device. Organic layers 55 include a light-emitting layer, and can also include a hole-transporting layer, an electron-transporting layer, and other layers known to be useful in an OLED device. The materials comprising organic layers 55 have been described in detail in U.S. Pat. No. 6,555,284 by Boroson et al. The circuit includes three voltages: power voltage (PV_{DD}) 15 that is connected to the source 20 of transistor 25; gate voltage (V_{G}) 35 that is connected to gate 40 of transistor 25; and cathode voltage (CV) 45 that is connected to the cathode 60 of the organic layers 55. Drain 30 of transistor 25 is connected to anode 50 of organic layers 55. The difference between power voltage 15 and cathode voltage 45 (PV_{DD}−CV) is the drive voltage for the device. Gate voltage 35 represents the luminance intensity signal. It will be understood that OLED circuits are frequently more complex than OLED circuit 10, and can include additional transistors, capacitors, select lines, etc., or can include different components such as n-type transistors or current source elements. For example, a simple two thin-film-transistor circuit is shown in U.S. Pat. No. 5,550,066 using a first transistor, or power transistor, for driving the OLED, a second transistor for selecting the pixels in a row, and a storage capacitor for storing the gate voltage for the duration of the frame. Other variations of this basic design are shown in U.S. Pat. Nos. 6,429,599 and 6,476,419. Yet another circuit design is shown in U.S. Pat. No. 6,501,448 where two parallel transistors are connected in series between the OLED and the power voltage and cathode voltage. In this type of design the two transistors are physically spaced in order to increase robustness to variability, but together serve the same function as the single power transistor discussed above. In the above examples, the pixels are typically driven using a voltage data signal. However, alternate designs where a current data signal is applied have been described. Examples of such current data signal circuits are discussed in U.S. Pat. Nos. 6,501,466 and 6,535,185. In these examples, the basic circuit element of a power transistor connected in series between the power voltage and cathode voltage remains. There are yet other examples such as discussed in U.S. Patent Application 2003/0040149A1 and U.S. Pat. No. 6,577,302 where an additional transistor is located in series with the power transistor between the power voltage and gate voltage. The examples included herein are based on the circuit shown in FIG. 1. Those skilled in the art will understand that the methods discussed would apply to other OLED circuits as well.

It will be useful to define the following voltage relationships:
V_{SD}=V_{source}−V_{drain}
V_{DS}=−V_{SD}
V_{OLED}=V_{anode}−V_{cathode}
PV_{DD}−CV=V_{SD}+V_{OLED}=−V_{DS}+V_{OLED}.

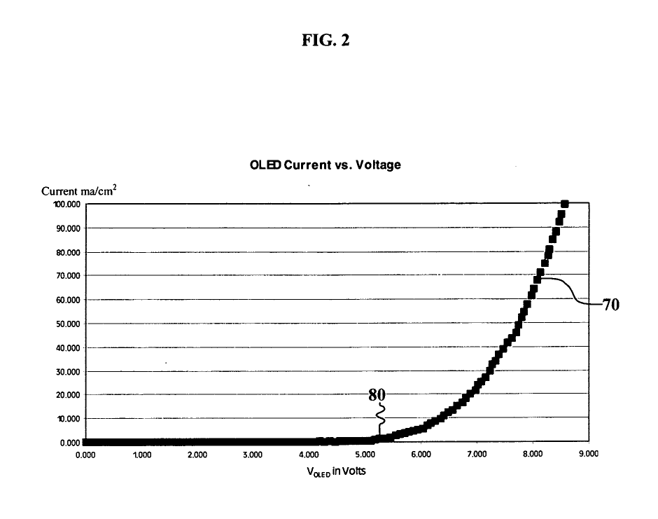

FIG. 2 shows a graphical representation of a current-voltage curve 70 for an OLED display, which is the response of the current through an OLED display to the voltage difference V_{OLED} between the anode and cathode of the display. Below a certain characteristic threshold voltage 80, little or no current passes through the organic layers. Above the threshold voltage 80, current passes and, if there are no other restrictions, the current increases with increasing voltage. Since the light emitted by an OLED display is dependent on the current, the luminance follows this same relationship.

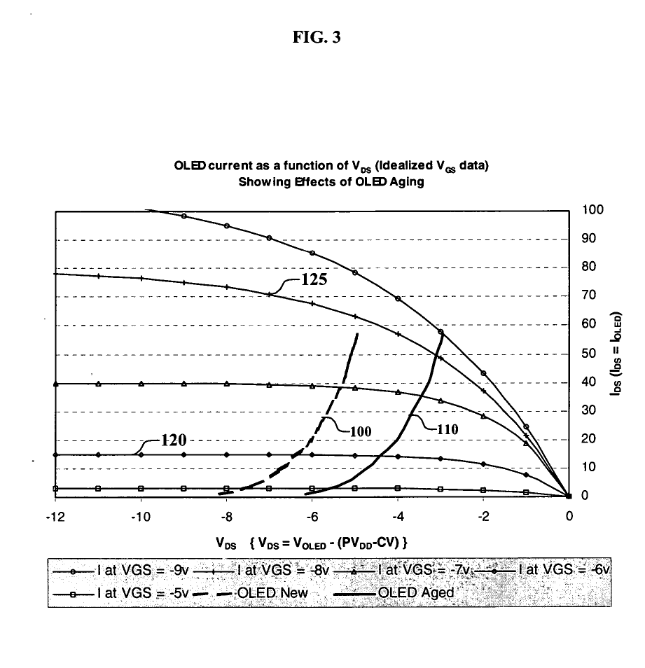

FIG. 3 shows a graphical representation of current-voltage curves for new and aged OLED displays (current-voltage curves 100 and 110) in comparison to a series of characteristic curves of current vs. V_{DS} for a thin-film transistor at different gate voltages (e.g. characteristic curves 120 and 125). As V_{DS} is made more negative, for example by making the cathode voltage CV more negative, current I_{DS} through the transistor increases until the saturation regime is reached, as in characteristic curve 120 below about −4v. Current-voltage curve 100 shows the current response of organic layers 55 of a new OLED display to voltage. The intersection with the transistor characteristic curve will determine the current that flows through the OLED display. At a V_{G} of −6v, the current through transistor 25 (and thus also through organic layers 55) will be approximately 15 ma/cm². At a V_{G} of −8v, the current will be over 60 ma/cm². Typically, the PV_{DD}−CV range is selected such that the transistor is preferably in the saturation regime where it intersects current-voltage curve 100 for all gate voltages utilized by the display.

FIG. 3 also shows current-voltage curve 110, which is a current-voltage curve of an aged OLED display that is an OLED display that has been operated for a period of time and shows changes in emission properties. Aging is a common problem that must be compensated for in OLED devices. At a V_{G} of −6v, the current through the device will be 14-15 ma/cm², which is very little change from that of a new display. At a V_{G} of −8v, the current will be less than 50 ma/cm², which represents almost a 20% drop in current (and therefore luminance) compared to the new OLED display.

One solution to aging, which is to run the device at a V_{G} closer to zero, is not attractive because it limits the luminance range of the device. In order to permit for aging, as well as possible manufacturing variation, it is frequently necessary to set the drive voltage for the display as high as possible, for example by setting the cathode voltage CV very negative. In many cases CV can be set more negative than necessary for a display, resulting in greater power use, excess heat, and a shorter lifetime of the display.

Furthermore, the power requirements for OLED devices to maintain the same level of luminance are known to increase with age. To compensate for this, the drive voltage of an OLED device is generally set at a level that will provide adequate response for an aged device, leading to greater than necessary power consumption of a relatively new device.

The use of higher drive voltages than needed provides no display advantage. It instead leads to higher power consumption and the generation of excess heat, which can lead to a shorter device lifetime. In addition, many of the conceivable uses for OLED displays are in portable devices, such as laptop computers, portable DVD players, and PDA's, which are often battery powered. A lower power consumption can therefore have benefits to the user in terms of usable time between charges.

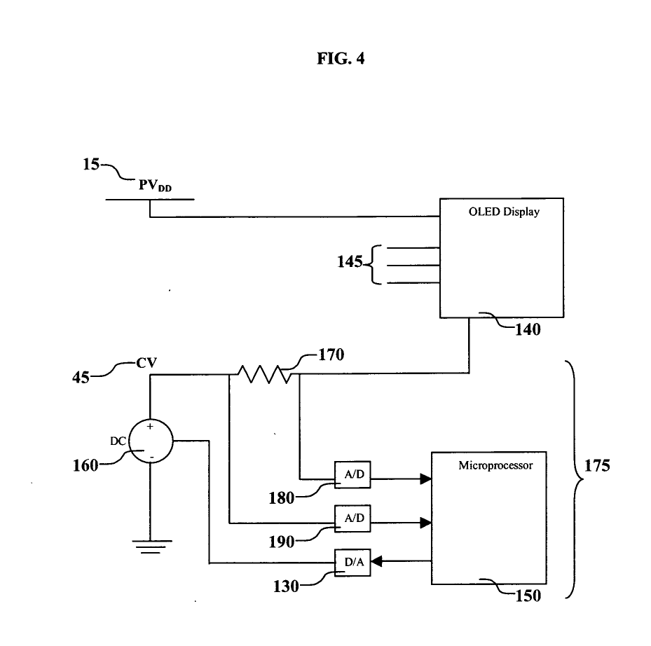

Turning now to FIG. 4, there is shown a schematic view of one type of measurement circuit and apparatus that can be used according to the method of this invention for varying the cathode voltage and measuring the current through an OLED display. OLED display 140 typically includes a large number of individual OLED circuits 10 (shown in FIG. 1). OLED display 140 includes one or more data signal inputs 145 for each emission color. Data signal inputs 145 can carry data signals, e.g. voltage signals, current signals, or digital words that get converted to voltage or current on OLED display 140. The data signals from data signal inputs 145 are used to set the VG of the various pixels in the display by a method that depends on the actual display circuitry. Control circuitry 175 can control the cathode voltage CV, measure a voltage drop across a known resistor, and calculate the current. Control circuitry 175 comprises microprocessor 150, digital-to-analog converter 130, analog-to-digital converters 180 and 190, DC converter 160, and resistor 170. Control circuitry 175 can be an external device, or can be built into the drive circuitry for OLED display 140. Microprocessor 150 controls the cathode voltage CV through digital-to-analog converter 130 and DC converter 160. Microprocessor 150 also measures the voltage drop across resistor 170 via analog-to-digital converters 180 and 190 and thereby calculates the current that passes through OLED display 140. Instead of measuring the current, the apparatus can include a device such as a photomultiplier for measuring the luminance of OLED display 140. Those skilled in the art will understand that there are other ways of performing the current and luminance measurements, including measuring the current from PV_{DD}. Microprocessor 150 can therefore determine the current and luminance of OLED display 140 in response to changes in the cathode voltage 45. If desired, microprocessor 150 can also be programmed to determine the optimum value for the cathode voltage 45. The optimum cathode voltage will be further discussed below.

The method described herein can be performed on a complete OLED display or any desired portion thereof. As such, the data signal used during each step of the method will affect each pixel in the activated portion of the display. Also, the current or luminance measured is the total for the activated pixels.

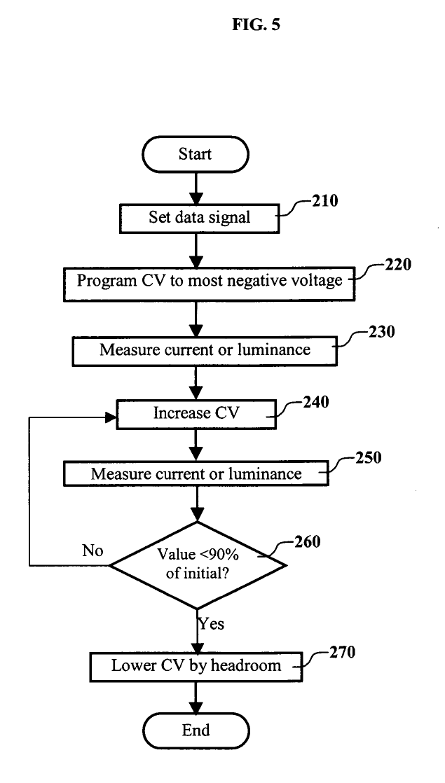

Turning now to FIG. 5, there is shown a block diagram of one embodiment of a method for selecting an adjustment to a drive voltage used to drive an OLED display so as to reduce power consumption according to this invention. The apparatus is first programmed with a data signal, which in turn imparts a gate voltage V_{G} to each thin-film transistor that produces the desired luminance (Step 210). The cathode voltage is then programmed to be at the most negative voltage anticipated to operate the display (Step 220) and the initial value of the current or luminance is measured (Step 230). The initial cathode voltage can be set so that the drive voltage (PV_{DD}−CV) is as high a value as would ever be used for a device of this type, accounting for manufacturing variability and aging effects. The cathode voltage is raised by a predetermined increment (Step 240), and the current or luminance is measured (Step 250). If the current or luminance measured in Step 250 is not less than a predetermined percentage (for example, 90%) of the initial value (Step 260), Steps 240 and 250 are repeated. If the current or luminance measured in Step 250 is lower than the predetermined percentage of the initial value (Step 260), the cathode voltage is made more negative by an amount that will provide sufficient headroom against aging (Step 270). This represents a selected adjustment for the drive voltage, as will be seen. The selected adjustment will be stored for use during normal operation of the OLED display.

If desired, Steps 240 and 250 can be further repeated beyond the predetermined percentage of initial current or luminance so as to produce a complete calibration curve by which one can determine the proper cathode voltage by other methods, e.g. visual inspection. While such calibration curves are depicted herein for clarity of illustration, it will be understood that it is unnecessary to determine the most unsuitable regions of the calibration curves in an automatic determination.

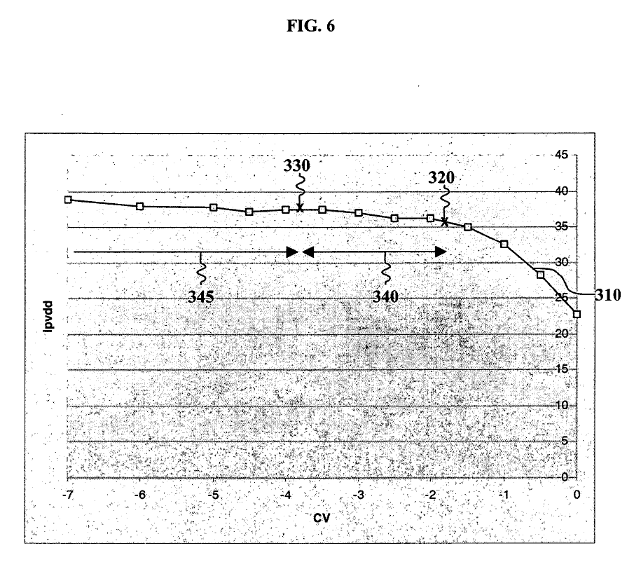

Turning now to FIG. 6, there is shown a calibration curve obtained by the method of this invention showing the optimum cathode voltage and an adjustment to the voltage to reduce the power consumed. Calibration curve 310 was obtained by the method of FIG. 5 and shows the cathode voltage vs. the current in milliamps for an OLED device with a single-color emitter. A calibration curve depicting cathode voltage vs. luminance can be used if luminance of the OLED device is the measured value. It will be understood that while this invention concerns the drive voltage, which is defined as PV_{DD}−CV, varying CV while holding PV_{DD} constant and then plotting current or luminance vs. CV provides one of a number of convenient methods of practicing this invention. One can depict the drive voltage vs. current or luminance and produce the same result. One can instead vary PV_{DD}, and plot current vs. PV_{DD} or P_{VDD}−CV. The initial cathode voltage of −7v is the default cathode voltage for this display, with a PV_{DD} of +7v to give a drive voltage of 14v. It can be seen that calibration curve 310 has only a small slope from the initial cathode voltage of −7v to a voltage of −2v. Above −2v, the curve slopes noticeably downward and the current drops to less than 90% of the initial value of 39 ma (at −7v). Therefore, the highest voltage at which this display will provide acceptable performance is maximum voltage 320, which is about −2v. Since the drive voltage is PV_{DD}−CV, maximum voltage 320 represents the minimum drive voltage that will provide acceptable performance.

The optimum voltage can be defined in a number of ways, depending on the characteristics of the display and how it is to be used. For example, if it is known that the particular organic layers in this display show an aging effect equivalent to a 2v shift (e.g. the difference between current-voltage curves 100 and 110 in FIG. 3) during the lifetime of the OLED display, it will be necessary to compensate for this change. In this graph, aging will be seen by movement of maximum voltage 320 to more negative values. It will be necessary to set the cathode voltage CV at −2v from maximum voltage 320. This would be optimum voltage 330, so-called because it includes headroom 340 sufficient to permit compensation for aging over the lifetime of the OLED display, but does not make CV excessively negative. Making CV more negative than optimum voltage 330 would increase the power loss of the display without providing any additional benefit. Adjustment 345 represents an adjustment to the drive voltage by setting CV at −4v instead of at −7v. Adjustment 345 can be selected based on calibration curve 310. Applying adjustment 345 will reduce the drive voltage and therefore the power consumed by the OLED display while maintaining, by virtue of headroom 340, the desired luminance throughout the lifetime of the OLED display.

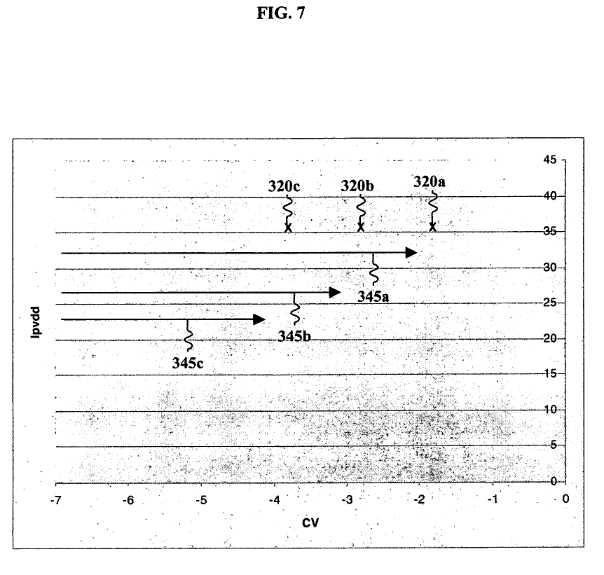

An alternative definition of optimum voltage can be considered for a device that includes control circuitry 175 of FIG. 4 in the driving circuitry for the OLED display. Such a device can periodically test the current vs. voltage characteristics of the display as described in FIG. 5, for example at display power-on. Under these conditions, an OLED display would need much less headroom 340, as it would need to compensate for a much shorter aging time. Thus, optimum voltage 330 can be set e.g. −0.2v from maximum voltage 320, since maximum voltage 320 will be periodically redetermined. This means that the adjustment to cathode voltage CV (and to drive voltage P_{VDD}−CV) will be changed periodically to adjust for changes in the OLED display. FIG. 7 shows how the maximum voltage and the selected adjustment for drive voltage can change with aging of the OLED display in such a device. For clarity, the calibration curves used to determine the maximum voltages are not shown. When new, a calibration curve for the OLED display will have a maximum voltage 320a. Based upon a calibration curve, an adjustment 345a for the drive voltage will be selected so as to reduce the power consumed by the OLED display while maintaining desired luminance. After a period of time, a new calibration curve will be produced, a new maximum cathode voltage will be determined, and a new adjustment for the drive voltage will be selected to adjust for changes in the OLED display. Thus, after some usage, the OLED display can have a maximum voltage 320b, and an adjustment 345b will be selected. Near the end of the lifetime of the OLED display, it can have a maximum voltage 320c, and an adjustment 345c will be selected. This would result in a greater power savings, over the lifetime of the OLED display, than a single initial adjustment for the drive voltage.

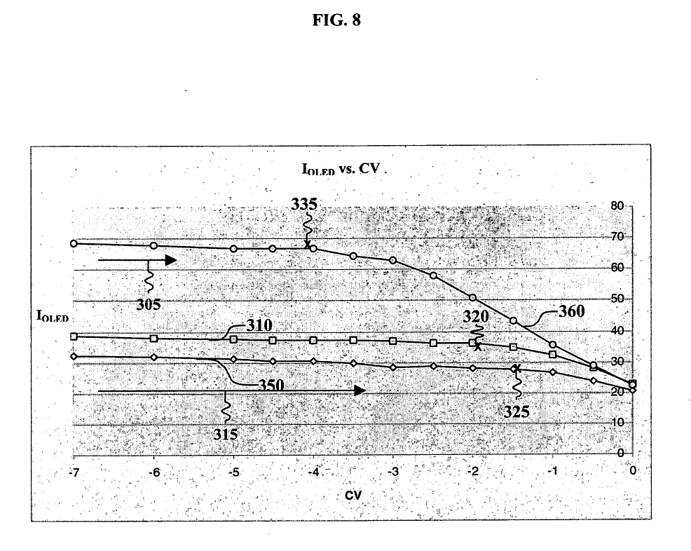

Turning now to FIG. 8, there is shown a series of calibration curves obtained by the method of this invention showing the maximum cathode voltage at several different brightness levels. By brightness level, it is meant the level of luminance that would be obtained if all the pixels being measured emitted at the maximum luminance (that is, not attenuated for scene display) permitted by the given data signal strength. Calibration curves 350, 310, and 360 were obtained by the method of FIG. 5 at decreasing gate voltages and show the cathode voltage vs. the current in milliamps for an OLED display with a single-color emitter. For calibration curve 350, the highest cathode voltage that will provide acceptable performance is maximum voltage 325, at about 1.5v. For calibration curve 310, maximum voltage 320 is at about −2.0v. For calibration curve 360, maximum voltage 335 is at about −4.0v. One can then use the techniques described above to determine the optimum voltage for each calibration curve, and thereby select an adjustment to the drive voltage.

The data can be applied in several ways. In one embodiment, one can determine that the maximum brightness level that the display will be subjected to is represented by e.g. calibration curve 360, and select the adjustment to the drive voltage based upon this curve. Therefore, the adjustment to the drive voltage is set for the worst case of a given display. This will reduce the power consumed by the OLED display while maintaining desired luminance for the lifetime of the OLED display.

In another embodiment, one can use the calibration curve data to base the selected adjustment for the drive voltage upon the usage of the OLED display. For example, if the usage of the OLED display includes several different brightness levels, the adjustment for the drive voltage would be selected based on the brightness level at which the OLED display is operating. If microprocessor 150 in FIG. 4 also includes the means for determining the brightness level of the OLED display, it can select the optimum adjustment for the drive voltage for the given brightness level. Thus the microprocessor can adjust the drive voltage based on the usage of the device, which would reduce the power consumed by the OLED display during periods of sub-maximum brightness. If the display is driven at the brightness that is characteristic of calibration curve 360, the microprocessor can select adjustment 305 for the drive voltage. If the display is being driven at the brightness corresponding to calibration curve 350, the microprocessor can select adjustment 315 for the drive voltage. This will further reduce the power consumed by the OLED display while maintaining desired luminance at all brightness levels throughout the lifetime of the OLED display.

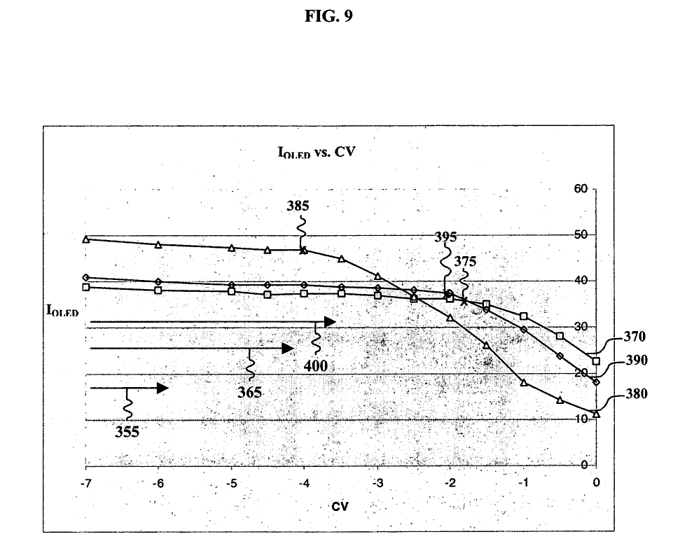

Turning now to FIG. 9, there is shown a series of calibration curves produced by the method of this invention for the emission of three different color channels of an OLED display. Calibration curves 370, 380, and 390 were obtained by operating the display by the method of FIG. 5 applied to each color channel, thereby producing a calibration curve for each color channel, and show the cathode voltage vs. the current in milliamps for the red, green, and blue channels, respectively, of an OLED device. For calibration curve 370, the highest cathode voltage that will provide acceptable performance is maximum voltage 375, which is about −1.8v. For calibration curve 380, maximum voltage 385 is at about 4.0v. For calibration curve 390, maximum voltage 395 is at about −2.0v. One can then use the techniques described above to determine the optimum voltage for each color channel, and thereby select an adjustment for the drive voltage.

The data can be applied in several ways. In one embodiment, the adjustment to the drive voltage can be selected based on the calibration curve that produces the least desirable drive voltage. The calibration curve showing the greatest power demand is calibration curve 380, which has a maximum cathode voltage of −4.0v. To assure optimum brightness for all colors, one can select adjustment 355 for the drive voltage based on calibration curve 380. Therefore, the adjustment for the drive voltage is set for the worst case of a given display. This will reduce the power consumed by the OLED display while maintaining desired luminance throughout the lifetime of the OLED display.

In another embodiment, one can use the calibration curve data to select an adjustment for the drive voltage for each color channel of the OLED display based upon the calibration curve of the respective color channel. One can select adjustment 400 for the first channel (e.g. red) drive voltage based on calibration curve 370, adjustment 355 for the second channel (e.g. green) drive voltage based on calibration curve 380, and adjustment 365 for the third channel (e.g. blue) drive voltage based on calibration curve 390. This can be done with a separate cathode for each color channel, or with a separate anode for each color channel. By optimizing each color channel, the total power consumed by the OLED device will be reduced while maintaining the desired luminance for each color channel throughout the lifetime of the OLED display.

It can be advantageous under some circumstances to combine the embodiments of FIG. 8 and FIG. 9, such as when an OLED display will be operated with different color temperatures. When the color temperature is changed, the brightness level for each of the colors can change individually. The combination of determining the adjustment for the drive voltage for each color at several different brightness levels can yield the optimal drive voltage adjustment(s) for each color temperature.

The invention has been described in detail with particular reference to certain preferred embodiments thereof, but it will be understood that variations and modifications can be effected within the spirit and scope of the invention.

### Parts List

10 OLED circuit
15 power voltage (PVDD)
20 source
25 thin-film transistor
30 drain
35 gate voltage (VG)
40 gate
45 cathode voltage (CV)
50 anode
55 organic layers
60 cathode
70 current-voltage curve
80 threshold voltage
100 current-voltage curve
110 current-voltage curve
120 characteristic curve
125 characteristic curve
130 digital-to-analog converter
140 OLED display
145 data signal inputs
150 microprocessor
160 DC converter
170 resistor
175 control circuitry
180 analog-to-digital converter
190 analog-to-digital converter
210 block
220 block
230 block
240 block
250 block
260 decision block
270 block
305 adjustment
310 OLED calibration curve
315 adjustment
320 maximum voltage
320a maximum voltage
320b maximum voltage
320c maximum voltage
325 maximum voltage
330 optimum voltage
335 maximum voltage
340 headroom
345 adjustment
345a adjustment
345b adjustment
345c adjustment
350 OLED calibration curve
355 adjustment
360 OLED calibration curve
365 adjustment
370 OLED calibration curve
375 maximum voltage
380 OLED calibration curve
385 maximum voltage
390 OLED calibration curve
395 maximum voltage
400 adjustment

1. A method for selecting an adjustment for at least one drive voltage used to drive an OLED display to reduce power consumption, comprising:
a) operating the display to produce a calibration curve which depicts the drive voltage versus current or luminance; and
b) selecting the adjustment for the drive voltage based upon the calibration curve so as to reduce the power consumed by the OLED display while maintaining desired luminance throughout the lifetime of the OLED display.

2. The method according to claim 1 wherein the selected adjustment for the drive voltage includes headroom sufficient to permit compensation for aging.

3. The method according to claim 2 wherein the selected adjustment for the drive voltage is based upon the usage of the OLED display.

4. A method for selecting an adjustment for a drive voltage used to drive at least three different color channels in an OLED display to reduce power consumption, comprising:
a) operating the display to produce a calibration curve for each color channel which depicts the drive voltage versus current or luminance; and
b) selecting the adjustment for the drive voltage based upon the calibration curve which produces the least desirable drive voltage so as to reduce the power consumed by the OLED display while maintaining desired luminance throughout the lifetime of the OLED display.

5. The method according to claim 4 wherein the selected adjustment for the drive voltage includes headroom sufficient to permit compensation for aging.

6. The method according to claim 5 wherein the selected adjustment for the drive voltage is based upon the usage of the OLED display.

7. A method for selecting adjustments for drive voltages used to respectively drive at least three different color channels in an OLED display to reduce power consumption, comprising:
a) operating the display to produce a calibration curve for each color channel which depicts the drive voltage versus current or luminance; and
b) selecting the adjustment for the drive voltage for each color channel based upon the calibration curves so as to reduce the power consumed by the OLED display while maintaining desired luminance throughout the lifetime of the OLED display.

8. The method according to claim 7 wherein the selected adjustments for the drive voltages include headroom sufficient to permit compensation for aging.

9. The method according to claim 8 wherein the selected adjustments for the drive voltages are based upon the usage of the OLED display.

10. A method for selecting an adjustment for at least one drive voltage used to drive an OLED display to reduce power consumption, comprising:
a) operating the display to produce a calibration curve which depicts the drive voltage versus current or luminance;
b) selecting the adjustment for the drive voltage based upon the calibration curve so as to reduce the power consumed by the OLED display while maintaining desired luminance; and
c) repeating steps (a) and (b) after a period of time to adjust for changes in the OLED display.

11. The method according to claim 10 wherein the selected adjustment for the drive voltage includes headroom sufficient to permit compensation for aging.

12. The method according to claim 11 wherein the selected adjustment for the drive voltage is based upon the usage of the OLED display.
